(19) United States
(12) Patent Application Publication
(10) Pub. No.: US 2016/0300050 A1
(43) Pub. Date: Oct. 13, 2016

(54) VERIFYING A USER WITH BIOMETRIC DATA

(71) Applicant: GM Global Technology Operations LLC, Detroit, MI (US)

(72) Inventors: Ron M. Hecht, Raanana (IL); Omer Tsimhoni, Ramat Hasharon (IL); Xufang Zhao, Windsor (CA); Gaurav Talwar, Novi, MI (US)

(73) Assignee: GM Global Technology Operations LLC, Detroit, MI (US)

(21) Appl. No.: 14/288,669

(22) Filed: May 28, 2014

(51) Int. Cl. G06F 21/32; H04W 12/08; G10L 17/00; H04W 12/06; G06K 9/00

(52) U.S. Cl. CPC G06F 21/32; H04W 12/06; G06K 9/00288; G10L 17/005; H04W 12/08

(57) ABSTRACT

A system and method of verifying a biometric variable of a handheld wireless device user includes: receiving at a wireless device a biometric variable measured using a handheld wireless device; detecting the biometric variable at the wireless device in response to receiving the biometric variable measured using the handheld wireless device; performing feature recognition at the wireless device on the detected biometric variable; comparing the feature recognition performed at the wireless device with the biometric variable measured using the handheld wireless device; permitting access to one or more features available at the wireless device or the handheld wireless device when the comparison is within a predetermined range of values; and denying access to the wireless device or the handheld device when the comparison is outside of the predetermined range of values.

### TECHNICAL FIELD

The present invention relates to verifying biometric variables, and more particularly to verifying biometric variables that are measured using more than one wireless device.

### BACKGROUND

Wireless devices are carried by an ever-increasing number of users. As users carry the wireless devices for extended periods of time, the devices store larger amounts of sensitive information. In some cases, the wireless devices implement a mechanism to authenticate the users of the devices and prevent unauthorized access of the sensitive information. While passwords have been used to prevent unauthorized access, more sophisticated techniques have supplanted the use of passwords and involve verifying the biometric features or variables of the user, such as their appearance or voice, before granting access. However, the accuracy with which wireless devices identify these biometric variables may not be high enough for certain applications. As a result, it would be helpful to increase the accuracy of user authentication using biometric variables.

### SUMMARY

According to an embodiment, there is provided a method of verifying a biometric variable of a handheld wireless device user. The method includes receiving at a wireless device a biometric variable measured using a handheld wireless device; detecting the biometric variable at the wireless device in response to receiving the biometric variable measured using the handheld wireless device; performing feature recognition at the wireless device on the detected biometric variable; comparing the feature recognition performed at the wireless device with the biometric variable measured using the handheld wireless device; permitting access to one or more features available at the wireless device or the handheld wireless device when the comparison is within a predetermined range of values; and denying access to the wireless device or the handheld device when the comparison is outside of the predetermined range of values

According to another embodiment, there is provided a method of verifying a biometric variable of a vehicle user. The method includes receiving at a vehicle a biometric variable measured using a handheld wireless device; detecting the biometric variable at the vehicle in response to receiving the biometric variable measured using the handheld wireless device; performing feature recognition at the vehicle on the detected biometric variable; comparing the feature recognition performed at the vehicle with the biometric variable measured using the handheld wireless device; permitting access to one or more vehicle features when the comparison is within a predetermined range of values; and denying access to the one or more vehicle features when the comparison is outside of the predetermined range of values.

According to yet another embodiment, there is provided a method of verifying a biometric variable of a vehicle user. The method includes detecting a biometric variable of the vehicle user using a handheld wireless device; performing an identification analysis of the biometric variable using the handheld wireless device; wirelessly transmitting the detected biometric variable, the identification analysis, or both to a vehicle; receiving the biometric variable, the identification analysis, or both at the vehicle; detecting the biometric variable of the vehicle user using vehicle hardware; performing an identification analysis at the vehicle of the biometric variable detected using vehicle hardware; and comparing the identification analysis performed at the vehicle to the received biometric variable, the received identification analysis, or both.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting an embodiment of an automatic speech recognition system (ASR); and

FIG. 3 is a flow chart depicting an embodiment of a method of verifying a biometric variable of a vehicle user.

### DETAILED DESCRIPTION OF THE ILLUSTRATED EMBODIMENTS

The system and method described below verifies a user of a handheld wireless device or a user of a vehicle based on the analysis of both a full detector system and a simple verification system. The full detector system can be implemented at a handheld wireless device and measure a biometric variable of the user, such as the features of a face or the sound of a voice, and attempt to determine the user's identity by analyzing this measurement with respect to a previously-measured biometric variable of the user. When relied on alone, these measurements made by the full detector system may not always correctly identify the user. For instance, the full detector system may not only fail to allow access when it should, the system may also allow access when it should not. Even though such a failure may occur only once in 500 measurements of biometric variables, this rate may be unacceptable to adequately secure a vehicle or handheld device.

This failure rate can be reduced by transmitting the biometric variable measured by the full detector system to the simple verification system. The full detector system can be implemented as a more complex mechanism for authenticating a user via a biometric variable relative to the mechanism used by the simple verification system. One way the full verification system differs from the simple verification system is that it measures many more data points of the biometric variable as part of authorization and performs a more in-depth analysis regarding whether the measured biometric variable matches a previously-measured biometric variable. When measuring the biometric variable of an unknown user, the full detector system can consume significant processing capability as the system carefully analyzes the unknown user. In contrast, the simple verification system can confirm the analysis of the full detector by receiving the analysis of the full detector (i.e., that the user has been authorized) and the biometric variable measurement from the full detector. The simple verification system can then extract a subset of the data points analyzed by the full detector from the received biometric variable measurement, compare those extracted data points to those data points in its own measurement of the biometric variable, and confirm the analysis of the full detector. The simple verification system then agrees or disagrees with the analysis generated by the full detector system. If the simple verification system knows that the full detector system has confirmed the identity of the user, the relatively small number of data points analyzed by the simple verification system can confirm the results of the full detector system. By performing a more cursory analysis of the biometric variable and relying on the results of the full detector system, the simple verifier can more simply and economically implement a security system. The simple verifier can also increase the accuracy of the full detector system.

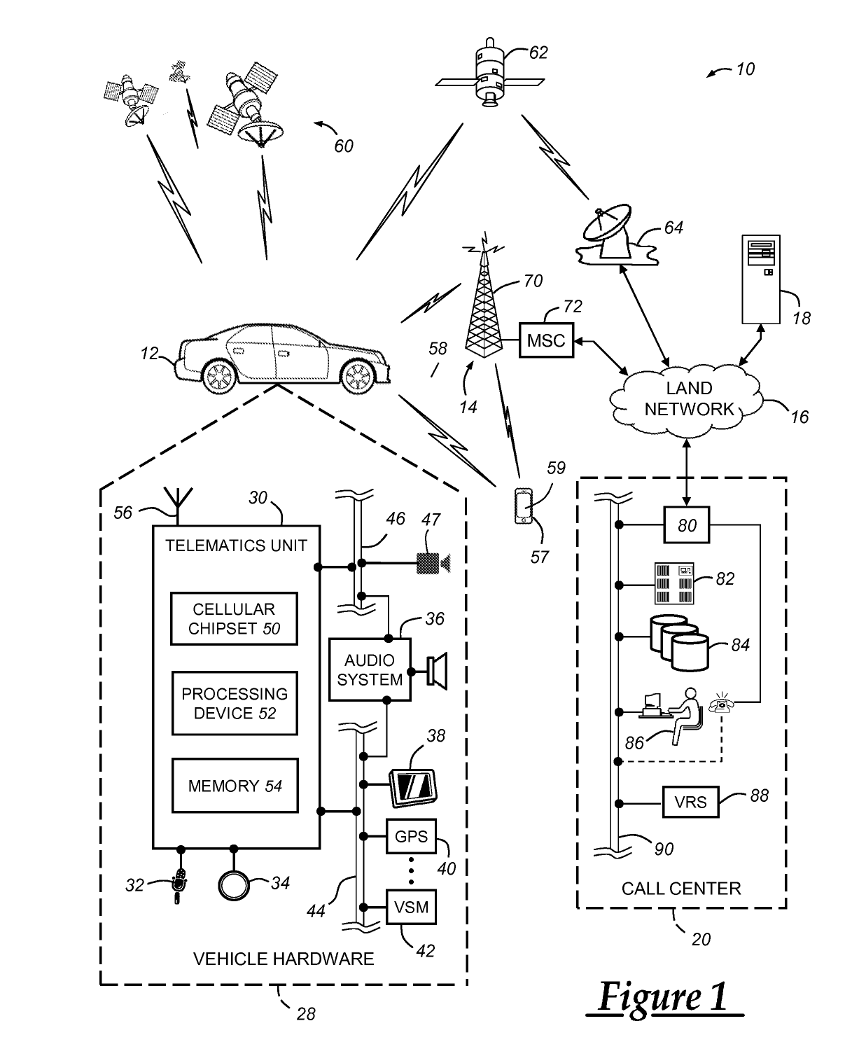

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a handheld wireless device, such as a smart phone 57. The smart phone 57 can include computer processing capability, a transceiver capable of communicating using a short-range wireless protocol, a microphone for receiving speech, one or more digital cameras capable of capturing still photographs and video, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple, Inc. and the Android™ manufactured by a number of other smart phone producers. While the smart phone 57 may include the ability to communicate via cellular communications using the wireless carrier system 14, this is not always the case. For instance, Apple manufactures devices such as the various models of the iPad™ and iPod Touch™ that include the processing capability, the display 59, and the ability to communicate over a short-range wireless communication link. However, the iPod Touch™ and some iPads™ do not have cellular communication capabilities. Even so, these and other similar devices may be used or considered a type of handheld wireless device, such as the smart phone 57, for the purposes of the method described herein. And it should also be appreciated that the wireless device need not necessarily be handheld to be used with the system and method(s) described herein. For instance, a wide variety of devices, such as televisions and vending machines, have become enabled with wireless communications technologies that can be cellular or short-range.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, visual display 38, and camera 47. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. The camera 47 can be one or more digital cameras that are installed in the rear view mirror of the vehicle 12 or in a way that they are aimed at vehicle users approaching the vehicle 12. While the camera 47 is shown as being connected to the vehicle telematics unit 30 via the entertainment bus 46, it is possible that the camera 47 can alternatively be linked to the vehicle telematics unit 30 via the communications bus 44 or to the unit 30 directly. Various other vehicle user interfaces can also be used, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

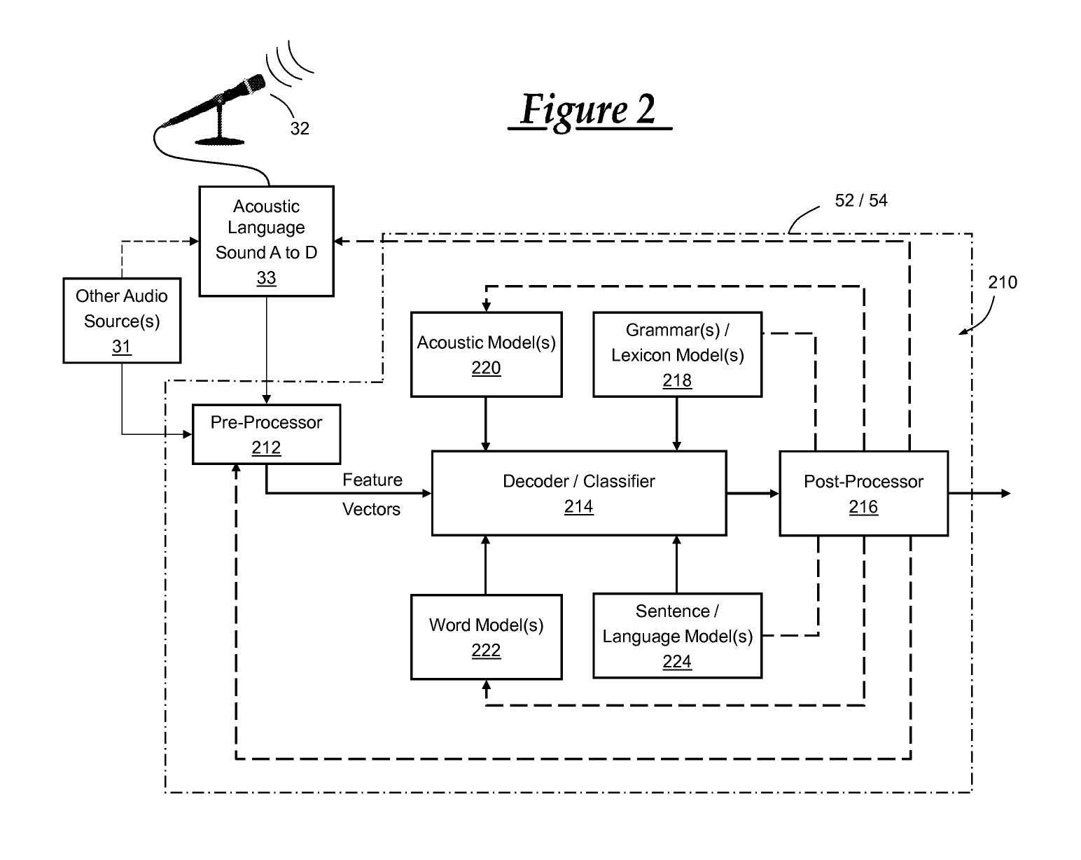

Turning now to FIG. 2, there is shown an illustrative architecture for an ASR system 210 that can be used to enable the presently disclosed method. In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific illustrative ASR system 210. The system 210 includes a device to receive speech such as the telematics microphone 32, and an acoustic interface 33 such as a sound card of the telematics unit 30 having an analog to digital converter to digitize the speech into acoustic data. The system 210 also includes a memory such as the telematics memory 54 for storing the acoustic data and storing speech recognition software and databases, and a processor such as the telematics processor 52 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances; and one or more post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative illustrative embodiment, some or all of the ASR system 210 can be resident on, and processed using, computing equipment in a location remote from the vehicle 12 such as the call center 20. For example, grammar models, acoustic models, and the like can be stored in memory of one of the servers 82 and/or databases 84 in the call center 20 and communicated to the vehicle telematics unit 30 for in-vehicle speech processing. Similarly, speech recognition software can be processed using processors of one of the servers 82 in the call center 20. In other words, the ASR system 210 can be resident in the telematics unit 30, distributed across the call center 20 and the vehicle 12 in any desired manner, and/or resident at the call center 20.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 ms duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

The method or parts thereof can be implemented in a computer program product embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

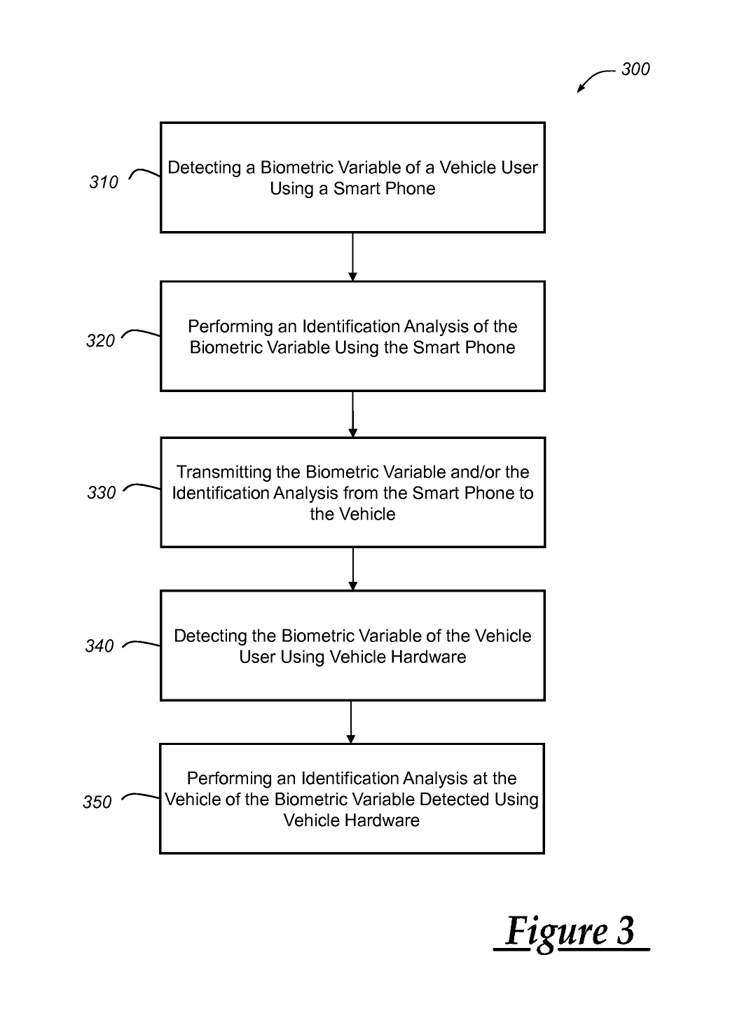

Turning now to FIG. 3, there is shown a method 300 of verifying a biometric variable of a vehicle user. The method 300 begins at step 310 by detecting a biometric variable of the vehicle user using a handheld wireless device. The handheld wireless device of method 300 will be described using the smart phone 57. However, it should be appreciated that other types of handheld wireless devices could also be used successfully with the method 300. And other wireless devices can be substituted for the vehicle 12 regardless of whether they are handheld or mobile. Furthermore, with respect to the method 300, the smart phone 57 can act as a full detector system while the vehicle 12 or vehicle telematics unit 30 can act as a simple verification system. The biometric variable can be a measurement of a unique feature belonging to or produced by the human body that is quantifiable by one or more sensing features of the smart phone 57. Biometric variables include the vehicle user's voice, facial features, signature, or fingerprints to name a few examples. The sensing features of the smart phone 57 can translate measurable aspects of the biometric variable into data points readable by the microprocessor of the smart phone 57. The sensing features used by the smart phone 57 can depend on the type of biometric variable measured. For example, when detecting the facial features of the vehicle user, the smart phone 57 can use its camera to capture an image of the vehicle user. In another example, the smart phone 57 can use its microphone to receive speech from the vehicle user when analyzing the vehicle user's voice. The method 300 proceeds to step 320.

At step 320, an identification analysis of the biometric variable is performed using the smart phone 57. Once the smart phone 57 has measured a biometric variable of the vehicle user, the smart phone 57 can then compare that biometric variable with a previously-stored biometric variable measurement to carry out feature recognition. The vehicle user can establish one or more previously-stored biometric variable measurements that can act as a baseline from which the smart phone 57 serves as a full detector system and compares the measured biometric variable with the previously-stored biometric variable measurement. The previously-stored biometric variable measurement can be stored at the smart phone 57 in one or more memory devices or could be accessed from a central facility, such as computer 18. Using facial recognition as an example of the biometric variable measured, the smart phone 57 can access a previously-taken photograph of the vehicle user that can be used as the previously-stored biometric variable measurement. The smart phone 57 can then apply its full detector system to compare the biometric variable it measured to the previously-stored biometric variable measurement. Various software is available to implement such a comparison that can compare the measured biometric variable in the form of a photograph of a vehicle user's face taken by the smart phone 57 to the previously-stored biometric variable measurement (a previously-stored photograph of the vehicle user) and generate an identification analysis that indicates with a confidence percentage how likely it is that the two images match. As discussed above, the identification analysis carried out by the full detector system can compare a relatively large number of data points in the measured biometric variable to data points measured from the previously-stored biometric variable. In one implementation, 1000 or more data points from the measured biometric variable can be compared to the previously-stored biometric variable. The identification analysis carried out by the full detector can include a decision of whether the two images match, the confidence percentage, or both.

In another implementation, it is also possible to use a segment of speech recorded from the vehicle user as the previously-stored biometric variable measurement. The smart phone 57 can record speech received from a vehicle user and store it as the previously-stored biometric variable measurement. The speech can be stored in a pulse-code modulation (PCM) file, for example. The smart phone 57 can then receive speech from the vehicle user via a microphone and perform speech recognition on the received speech. The speech recognition can be carried out using an ASR system that is stored locally on the smart phone 57. The ASR system can perform feature extraction from the recording that can be Cepstral-based, estimate the distribution of the features, transform the distributions into a single point in a high dimensional space (an array of feature values), and compare the single point to another point or other points that represent a base signature. This can include finding the distance between the two or more vectors/points. The ASR system can then compute distances to other vectors that represent other people, normalize the distances relative to other vectors in order to decide the likelihood that the compared point matches the base signature, and compare the results with a threshold that is based on one or more preset values for acceptance and rejection. It is also possible to wirelessly send speech received by the smart phone 57 to a central facility, such as a cloud-based computing system implemented as computer 18, that performs ASR on the received speech, compares the speech received from the vehicle user to the previously-stored speech, and then returns the results to the smart phone 57. The results from the ASR system can be included in an identification analysis that outputs a decision regarding whether the received speech matches the previously-stored speech, a confidence percentage of how likely it is that the received speech matches the previously-stored speech, or both. The method 300 proceeds to step 330.

At step 330, the detected biometric variable, the identification analysis, or both is wirelessly transmitted from the smart phone 57 to the vehicle 12. The smart phone 57 can establish a short-range wireless communication link with the vehicle telematics unit 30 and send the biometric variable measured or detected using the smart phone 57 to the unit 30 along with the identification analysis performed by the smart phone 57. The smart phone 57 can also send a computer-readable instruction alerting the vehicle 12 that the information sent over the short-range wireless communication link should be used for authentication purposes and may command the vehicle 12 to begin performing those services. The command to begin performing these services can also originate from the vehicle 12 for transmission to the smart phone 57. The short-range wireless communication link can be carried out using any one of the short-range wireless communication protocols set forth in the IEEE 802.11 standards.

The vehicle 12 and the smart phone 57 can also authenticate the identity of each other. For instance, the smart phone 57, acting as the full detector system, can inform the vehicle 12 using the simple verifier system that it has authenticated a user. The vehicle 12 may need to verify that the smart phone 57 is a trusted device before accepting the analysis and communications from the smart phone 57 as valid. This can be carried out using secret passwords, a trusted third party certificate verifier, or some other cryptographic techniques that are known. In addition, the vehicle 12 can communicate with several smart phones at once and be able to distinguish one smart phone from another. By receiving an identifier from each smart phone, the vehicle 12 can differentiate between the driver and the passengers, which can be helpful when several biometric sensors are in the vehicle 12 or even a single biometric sensor facing the driver. The method proceeds to step 340.

At step 340, the biometric variable of the vehicle user is detected using vehicle hardware. After receiving the biometric variable detected by the smart phone 57, the identification analysis, or both, and the smart phone 57 has been authenticated as a trusted device, the vehicle 12 can measure the same biometric variable as measured by the smart phone 57 using one or more hardware elements on the vehicle 12. For example, vehicle telematics unit 30 can receive an image of the vehicle user from the smart phone 57 as part of performing face recognition and the image can include a computer-readable instruction commanding the vehicle telematics unit 30 to verify the image with a photograph of the vehicle user taken using the camera 47 of the vehicle 12. The vehicle 12 can use the processor 52 to determine that the computer-readable instruction included with the received biometric variable (in this case, the image) commands the vehicle 12 to take a photograph of the vehicle user. The vehicle user can then stand outside of the vehicle 12 and the camera 47 can capture an image of the vehicle user. In another example, the vehicle telematics unit 30 can receive recorded speech of the vehicle user as the biometric variable with the computer-readable instruction commanding the vehicle 12 to verify the speech recorded by the smart phone 57. The vehicle 12 can then act on the computer-readable instruction to prompt the vehicle user to speak into the microphone 32, which can be mounted on the interior or exterior of the vehicle 12, so that the vehicle 12 can detect the biometric variable (i.e., speech) of the vehicle user. The method 300 proceeds to step 350.

At step 350, an identification analysis is performed at the vehicle 12 of the biometric variable detected using vehicle hardware. Once the vehicle 12 measures the biometric variable, the processor 52 of the vehicle telematics unit 30 can confirm the authentication determined by the smart phone 57 using the vehicle-measured biometric variable and the biometric variable sent from the smart phone 57. Broadly speaking, the vehicle 12 can perform an analysis that is simpler than that which was performed by the smart phone 57. The simple verifier system of the vehicle 12 can compare a subset of data from the measured biometric variable with a subset of data from the received biometric variable and confirm the result of the analysis carried out at the smart phone 57, or full detector. Using voice as the biometric variable, the vehicle 12 can perform feature extraction from a recording (usually Cepstral based) and estimate the distribution of the features. The distribution of the features can be transformed into a single point in a high dimensional space (an array of feature values) and compared to another point or other points that represent a base signature of the received biometric variable thereby finding the distance between the two or more vectors/points.

Rather than using a previously-stored biometric variable of the user, the vehicle 12 can compare the biometric variable measured at the vehicle 12 to the biometric variable measured by the smart phone 57 and/or the identification analysis of the smart phone 57. That way, the vehicle 12 may not need to rely on the previously-stored biometric variable of the user. When the biometric variable measured at the vehicle 12 is within a pre-determined range of values of the biometric variable measured by the smart phone 57 or the identification analysis of the smart phone 57, the vehicle 12 can confirm the verification carried out at the smart phone 57 and provide access to the vehicle 12 or one or more vehicle functions. Conversely, when the biometric variable measured at the vehicle 12 is outside of the pre-determined range of values of the biometric variable measured by the smart phone 57, the vehicle 12 can reject the identification analysis of the smart phone 57 and deny access to the vehicle 12 or one or more vehicle functions. Determining when the biometric variable measured at the vehicle 12 is within sufficient range of the biometric variable sent to the vehicle 12 can involve establishing a confidence value of greater than 1:1,000,000 chance of the two variables not matching. That is, if the chance of incorrectly determining that two variables match is greater than 1:1,000,000, the vehicle 12 can determine a match occurs and can permit access to vehicle functions such as door locks, vehicle starting, or infotainment use. Otherwise, the vehicle 12 can deny access to the vehicle functions.

It is to be understood that the foregoing is a description of one or more embodiments of the invention. The invention is not limited to the particular embodiment(s) disclosed herein, but rather is defined solely by the claims below. For example, the method 300 could also be carried out using two handheld wireless devices rather than the smart phone 57 and the vehicle 12/vehicle telematics unit 30. The handheld wireless devices could be the smart phone 57 as one handheld wireless device and another handheld wireless device in the form of a television remote control having ASR capability, a handheld tablet, or a video game console to provide a few examples of the different handheld wireless devices that could be used with the smart phone 57. Each of these devices can measure a biometric variable of the user and authenticate a user with the measured biometric variables from both handheld wireless devices. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of verifying a biometric variable of a handheld wireless device user, comprising the steps of:
(a) receiving at a wireless device a biometric variable measured using a handheld wireless device;
(b) detecting the biometric variable at the wireless device in response to receiving the biometric variable measured using the handheld wireless device;
(c) performing feature recognition at the wireless device on the detected biometric variable;
(d) comparing the feature recognition performed at the wireless device with the biometric variable measured using the handheld wireless device;
(e) permitting access to one or more features available at the wireless device or the handheld wireless device when the comparison in step (d) is within a predetermined range of values; and
(f) denying access to the wireless device or the handheld device when the comparison in step (d) is outside of the predetermined range of values.

2. The method of claim 1, further comprising the step of comparing the biometric variable measured using the handheld wireless device to a previously-stored biometric feature measurement of the handheld wireless device user.

3. The method of claim 1, further comprising the step of receiving at the wireless device an identification analysis performed by the handheld wireless device.

4. The method of claim 1, wherein the biometric variable further comprises a voice or a facial feature of the handheld wireless device user.

5. The method of claim 1, wherein the wireless device further comprises a smart phone.

6. A method of verifying a biometric variable of a vehicle user, comprising the steps of:
(a) receiving at a vehicle a biometric variable measured using a handheld wireless device;
(b) detecting the biometric variable at the vehicle in response to receiving the biometric variable measured using the handheld wireless device;
(c) performing feature recognition at the vehicle on the detected biometric variable;
(d) comparing the feature recognition performed at the vehicle with the biometric variable measured using the handheld wireless device;
(e) permitting access to one or more vehicle features when the comparison in step (d) is within a predetermined range of values; and
(f) denying access to the one or more vehicle features when the comparison in step (d) is outside of the predetermined range of values.

7. The method of claim 6, further comprising the step of comparing the biometric variable measured using the handheld wireless device to a previously-stored biometric feature measurement of the vehicle user.

8. The method of claim 6, further comprising the step of receiving at the vehicle an identification analysis performed by the handheld wireless device.

9. The method of claim 6, wherein the biometric variable further comprises a voice or a facial feature of the vehicle user.

10. The method of claim 6, wherein the handheld wireless device further comprises a smart phone.

11. The method of claim 6, further comprising the step of detecting the biometric variable at the vehicle using a camera or a microphone.

12. A method of verifying a biometric variable of a vehicle user, comprising the steps of:
(a) detecting a biometric variable of the vehicle user using a handheld wireless device;
(b) performing an identification analysis of the biometric variable using the handheld wireless device;
(c) wirelessly transmitting the detected biometric variable, the identification analysis, or both to a vehicle;
(d) receiving the biometric variable, the identification analysis, or both at the vehicle;
(e) detecting the biometric variable of the vehicle user using vehicle hardware;
(f) performing an identification analysis at the vehicle of the biometric variable detected using vehicle hardware; and
(g) comparing the identification analysis performed at the vehicle to the received biometric variable, the received identification analysis, or both.

13. The method of claim 12, further comprising the step of comparing the biometric variable measured using the handheld wireless device to a previously-stored biometric feature measurement of the vehicle user.

14. The method of claim 12, further comprising the step of receiving at the vehicle an identification analysis performed by the handheld wireless device.

15. The method of claim 12, wherein the biometric variable further comprises a voice or a facial feature of the vehicle user.

16. The method of claim 12, wherein the handheld wireless device further comprises a smart phone.

17. The method of claim 12, further comprising the step of detecting the biometric variable at the vehicle using a camera or a microphone.
